(19) United States
(12) Patent Application Publication
(10) Pub. No.: US 2025/0077238 A1
(43) Pub. Date: Mar. 6, 2025

(54) PRE-APPROVAL-BASED MACHINE CONFIGURATION

(71) Applicant: Microsoft Technology Licensing, LLC, Redmond, WA (US)

(72) Inventors: German David OBANDO CHACON, Kirkland, WA (US); Dayton Ross ELLWANGER, Kirkland, WA (US); Varun GUPTA, Bellevue, WA (US); Dhruv Chand MUTTARAJU, Seattle, WA (US); Jordan Lee MATTHIESEN, Battle Ground, WA (US)

(21) Appl. No.: 18/241,489

(22) Filed: Sep. 1, 2023

(51) Int. Cl. G06F 9/445; G06F 40/284; G06F 40/30

(52) U.S. Cl. CPC G06F 9/44505; G06F 40/284; G06F 40/30

(57) ABSTRACT

Some embodiments determine machine configuration intentions from a natural language description of a target machine configuration. Intentions are refined to remove ambiguity, and mapped to pre-approved configuration functions and tasks. A machine configuration task list which invokes the pre-approved configuration functions and tasks is generated by a stabilized language model, and is executed to configure a target machine. The requested target machine is produced without requiring a user or admin to spend substantial effort and time customizing the machine and confirming its security and policy compliance.

### BACKGROUND

Many modern devices in a broad range of fields have some form of computing power, and operate according to software instructions that execute using that computing power. A few of the many examples of devices whose behavior depends on software include cars, planes, ships and other vehicles, robotic manufacturing tools and other industrial systems, medical devices, cameras, inventory management and other retail or wholesale systems, smartphones, tablets, servers, workstations and other devices which connect to the Internet.

The firmware, operating systems, applications and other software programs which guide various behaviors of these and many other computing devices are developed by people who are known as developers, programmers, engineers, or coders, for example, they are referred to collectively here as “developers”. As they develop software, developers interact with software code and other digital resources, and with source code editors, compilers, debuggers, profilers, version control tools, and various other software development tools in a development environment.

The development environment typically includes software that runs on one or more virtual machines, e.g., in a cloud, or on one or more local physical machines, e.g., laptops or workstations, or on both virtual and local physical machines. The development environment also includes resources, e.g., source code, databases, images, interfaces, credentials, repositories, and more. The development environment also includes settings, e.g., environment variables, search paths, security permissions, user preferences, compiler flags, and more.

Terminology varies, but the process of providing a machine equipped with a development environment is often described as deploying or provisioning the machine. Configuring the machine is at least part of deploying or provisioning it. Depending on the situation, configuring a machine includes installing software on the machine or verifying that particular software is installed, installing resources or verifying that particular resources are installed, assigning values to settings or confirming that particular values have been assigned, or a mixture of the foregoing.

Billions of machines of various kinds, including many configured with development environments, have been deployed over the course of several decades. However, improvements in machine deployment technology are still possible.

### SUMMARY

Some embodiments address technical challenges arising from the complexity and variability of machine configurations, such as how to balance competing goals of security, customizability, and efficiency. Some embodiments optimize this balance by automatically and proactively determining machine configuration intentions from a natural language description of a target machine configuration. Intentions are mapped by the embodiment to pre-approved configuration functions. Execution of a machine configuration task list then invokes the pre-approved configuration functions in order to configure a machine. In some scenarios, the embodiment configures a newly available machine, and in other scenarios the embodiment reconfigures a previously available machine.

From a user perspective, entering the natural language description of the target machine configuration prompts the embodiment to produce the desired machine, which is configured as requested. Moreover, the requested machine is produced without requiring the user or admin personnel to spend substantial effort and time customizing the machine and confirming its security.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for systems which provide pre-approval-based machine configuration functionality;

FIG. 2 is a block diagram illustrating aspects of a family of enhanced systems which are each configured with pre-approval-based machine configuration functionality;

FIG. 3 is a block diagram illustrating aspects of another family of systems which are each enhanced with pre-approval-based machine configuration functionality;

FIG. 4 is a block diagram illustrating some aspects of machine configuration intentions;

FIG. 5 is a block diagram illustrating some aspects of machine configuration language model tailoring;

FIG. 6 is a block diagram illustrating some aspects of machine configuration functions and machine configuration tasks;

FIG. 7 is a flowchart illustrating steps in a pre-approval-based machine configuration method; and

FIG. 8 is a flowchart further illustrating steps in some pre-approval-based machine configuration methods, and incorporating FIG. 7.

### DETAILED DESCRIPTION

### Overview

Some teachings described herein were motivated by technical challenges faced during efforts to improve technology for customizing virtual machines for software developers. In particular, challenges were faced during efforts to improve Microsoft Dev Box, which is an Azure® service that gives developers self-service access to preconfigured, project-specific developer boxes (mark of Microsoft Corporation). These challenges were motivations, but teachings herein are not limited in their scope or applicability to the particular motivational challenges.

Configuring virtual machines for use as software development environments poses technical challenges, such as how to select between available configurations, and how to identify and mitigate security risks. The complexity and variability of machine configurations means that many different configurations are possible, e.g., which programming languages to install, which development tools to install, which development tool extensions (e.g., integrated development environment extensions) to install, which environment variable settings to use, which default settings to change in a tool, and which user preferences to set in a tool. Some configurations also pose security risks, e.g., by including tools with known vulnerabilities, which adds to the complexity.

Some approaches to machine configuration are developer-driven in that they rely primarily or entirely on a developer to make all of the choices regarding languages, tools, tool extensions, environment variables, default setting overrides, user preference settings, and other parts of a machine configuration. This approach maximizes customizability, because it imposes few if any constraints on the developer's choices.

However, this approach heavily burdens the developer, who must investigate many technical details and tradeoffs that are not at the core of the developer's primary responsibility, which is software development. Development efficiency is reduced. It is not unusual for a developer who uses this approach to spend hours on device configuration, which is time that could otherwise have been spent on actual development work.

Sometimes different developers taking this developer-driven approach call on admin personnel to handle similar requests, e.g., to tell the developer which installer to use for a given language or kernel, or where to find a particular tool or extension in order to download it. As a result, this approach also reduces administrative efficiency, by imposing on admins to answer the same question multiple times.

Moreover, this developer-driven approach often puts security at risk. Developers who do not happen to have a strong security focus will not necessarily take security measures, e.g., vet each tool for known security vulnerabilities, override insecure default values, and otherwise secure the machine being configured.

A different approach is admin-driven, in that it relies primarily or entirely on an admin to make the choices regarding languages, tools, tool extensions, environment variables, default setting overrides, user preference settings, and other parts of a machine configuration. These choices are often made in consultation with the developer, but the admin does not necessarily give the developer a machine that is configured entirely to the developer's satisfaction. The admin has less incentive than the developer to fine-tune a configuration, because the developer—not the admin—will not be working on the configured machine.

An admin-driven approach provides somewhat better development efficiency than the developer-driven approach, but does so at the cost of reduced admin efficiency and reduced customizability.

In theory, an admin-driven approach provides a more secure configuration than the developer-driven approach, because admins tend to have a stronger security focus than developers. However, in practice the admin may rely on a security perimeter outside the machine, in order to reduce time spent on behalf of this particular developer. This allows the admin to turn to other tasks, including security tasks, that will benefit multiple people.

A third approach is a mix of the prior two. Admins provide a limited menu of configured machines. The developer chooses one and then customizes it. However, efficiencies still suffer under this mixed approach. Developers still spend time investigating technical details of different configurations instead of spending that time on development. Admins still spend time answering the same question repeatedly when different developers want a customization not provided in the limited menu. Security is also still at risk, when developers assume incorrectly that anything on the limited menu will remain secure despite the impact of customizations by the developer.

Some variations improve the user interface by which a developer or admin makes configuration selections. However, inefficiency and insecurity disadvantages remain even when a graphical user interface is provided to help the developer or admin choose tools and tool extensions, set user preferences, and enter other configuration data.

Accordingly, other approaches are taught herein to improve the security, customizability, and efficiency of machine configuration workflow and results.

Some embodiments described herein determine, from a natural language description of a target machine configuration, a machine configuration intention of the natural language description. The determination activity includes a language model selecting a machine configuration function based on at least a pre-approval data structure which the selecting treats as an allow-set or treats as a deny-set. The determined machine configuration intention corresponds to the selected machine configuration function. This example embodiment also obtains, from the machine configuration intention via at least the language model, a machine configuration task list, and the embodiment configures the target machine to produce the configured target machine at least in part by executing the machine configuration task list.

In these example embodiments, this machine configuration functionality has the technical benefit of providing better development efficiency than a developer-driven approach, because the developer is not burdened with investigation of configuration details such as the choice of installer, the location of downloads, environmental variable settings, and so on. This machine configuration functionality also has the technical benefit of providing better admin efficiency than an admin-driven approach, because the admin is not burdened with answering developer queries. This machine configuration functionality also has the technical benefit of providing better security than some developer-driven or admin-driven approaches, because it does not inherently rely on a security perimeter outside the machine being configured or on the security of a limited menu of configured machines, and because use of insecure machine configuration functions will be avoided via the pre-approval data structure.

Some embodiments get an approximation of the machine configuration intention from the language model, and refine the approximation with respect to at least one of: a version identifier, a software identifier, a resource identifier, a software setting, or a user feedback. This machine configuration functionality has the technical benefit of relieving developers and admins of the burden of determining a current version's full version number, download source location, or exact name, for example.

In some embodiments, determining machine configuration intention of the natural language description includes zero-shot learning by the language model to learn a predefined set of machine configuration functions. This machine configuration functionality has the technical benefit of allowing the language model to classify previously unseen machine configuration functions, which allows the embodiment to efficiently allow or deny use of machine configuration functions implicated by developers without spending additional admin effort once the predefined set of machine configuration functions is chosen.

In some embodiments, determining machine configuration intention of the natural language description includes teaching the language model a catchall function in the predefined set of machine configuration functions, and the catchall function corresponds to a null effect machine configuration task. This machine configuration functionality has the technical benefit of fully excluding unapproved machine configuration functions from the machine configuration task list so they will not be executed, which improves security. The catchall serves as a trap for unapproved functions.

In some embodiments, determining machine configuration intention of the natural language description includes teaching the language model a predefined set of machine configuration tasks which constrains use of the machine configuration functions. A machine configuration task includes, e.g., an invocation of a machine configuration function with particular parameters. Some machine configuration functions can be used beneficially and securely, or instead be misused, depending for example on the parameters they are given. This machine configuration functionality has the technical benefit of excluding unapproved uses of machine configuration functions from the machine configuration task list so they are not executed, which improves security, while still allowing permitted uses of the same or other functions.

Some embodiments automatically and proactively validate the machine configuration task list. The validating includes at least one of: checking a syntax of the machine configuration task list, checking whether a path specified in the machine configuration task list exists, checking whether a resource specified in the machine configuration task list is accessible, checking whether a parameter value specified in the machine configuration task list is invalid, or checking whether a required parameter of a routine invocation specified in the machine configuration task list is present. In this context, a function invocation is an example of a routine invocation. This machine configuration functionality has the technical benefit of reducing or preventing errors during execution of the machine configuration task list, thereby conserving computational resources and avoiding incorrect, insecure, or inoperable machine configurations that would have resulted from executing an invalid task list.

These and other benefits will be apparent to one of skill from the teachings provided herein.

### Operating Environments

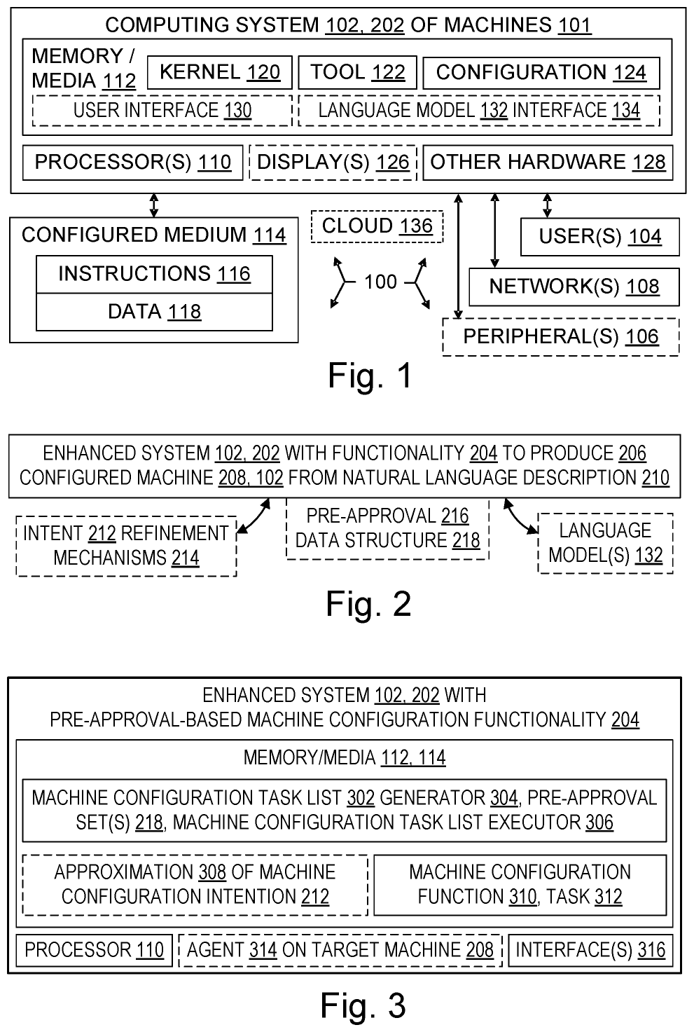

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface 130 by using displays 126, keyboards 106, and other peripherals 106, via typed text, touch, voice, movement, computer vision, gestures, and/or other forms of I/O. Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services, such an account is a de facto service account. Although a distinction could be made, “service account” and “machine-driven account” are used interchangeably herein with no limitation to any particular vendor.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, on mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or set of accounts, user 104 or group of users 104, IP address or group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, machine configuration functionality 204 could be installed on an air gapped network and then be updated periodically or on occasion using removable media 114, or not updated at all. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience, inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, data structures, computational resources, programming languages, tools, workflows, or algorithm implementations, or other items in a computing environment, which are disclosed herein but not associated with a particular reference numeral herein. Corresponding drawings may also be added.

### More About Systems

FIG. 2 illustrates a computing system 102 configured by one or more of the machine configuration functionality enhancements taught herein, resulting in an enhanced system 202. In some embodiments, this enhanced system 202 includes a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 shows some aspects of some enhanced systems 202. This is not a comprehensive summary of all aspects of enhanced systems 202 or all aspects of machine configuration functionality 204. Nor is it a comprehensive summary of all aspects of an environment 100 or system 202 or other context of an enhanced system 202, or a comprehensive summary of any aspect of functionality 204 for potential use in or with a system 102. FIG. 3 items are discussed at various points herein, and additional details regarding them are provided in the discussion of a List of Reference Numerals later in this disclosure document.

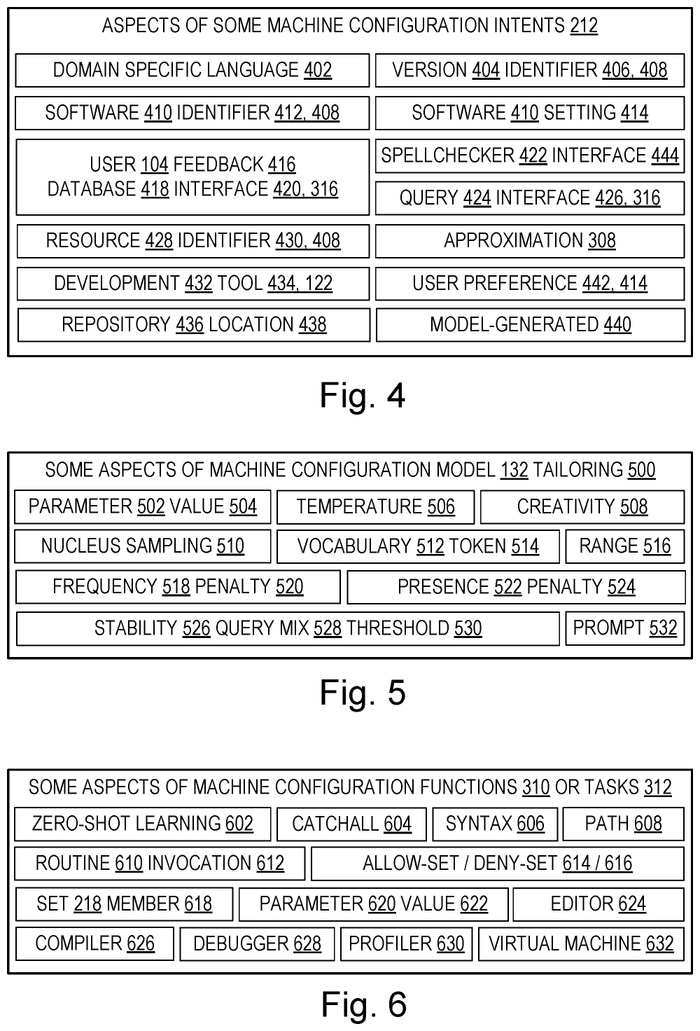

FIG. 4 shows some aspects of machine configuration intents 212. This is not a comprehensive summary of all aspects of machine configuration intents 212. FIG. 4 items are discussed at various points herein, and additional details regarding them are provided in the discussion of a List of Reference Numerals later in this disclosure document.

FIG. 5 shows some aspects of machine configuration model tailoring 500, e.g., parameters 502 which control or influence operation of a machine configuration language model 132. This is not a comprehensive summary of all aspects of machine configuration models 132 or their tailoring 500. FIG. 5 items are discussed at various points herein, and additional details regarding them are provided in the discussion of a List of Reference Numerals later in this disclosure document.

FIG. 6 shows some aspects of machine configuration functions 310 and tasks 312. A task 312 includes a function 310 and parameters 620 of the function. To help avoid confusion, language model parameters are designated 502 whereas function 310 parameters are designated 620. This difference in reference numerals reflects the usage role of a given parameter value, and does not necessarily prevent a given value (especially zero or one) from being used in both roles at various points. FIG. 6 is not a comprehensive summary of all aspects of machine configuration functions 310 and tasks 312. FIG. 6 items are discussed at various points herein, and additional details regarding them are provided in the discussion of a List of Reference Numerals later in this disclosure document.

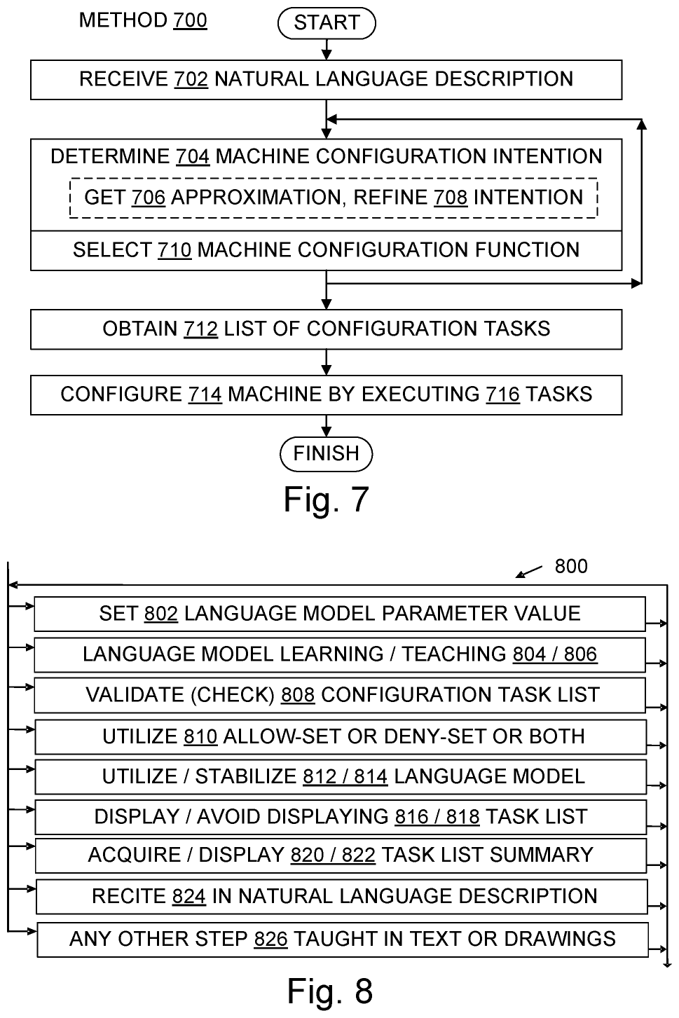

The other figures are also relevant to systems 202. FIGS. 7 and 8 illustrate methods of functionality 204 operation in systems 202.

In some embodiments, the enhanced system 202 is networked through an interface 316. In some, an interface 316 includes hardware such as network interface cards, software such as network stacks, APIs, or sockets, combination items such as network connections, or a combination thereof.

Some embodiments include a computing system 202 which is configured to produce a configured target machine. The computing system includes: a digital memory 112, and a processor set 110 including at least one processor, the processor set in operable communication with the digital memory. The system 202 also includes a machine configuration task list generator 304 including a language model 132, a pre-approval data structure 218 residing in the memory and representing a set of machine configuration functions 310, and a machine configuration task list executor 306. The machine configuration task list generator is configured to, upon execution by the processor set and via at least the language model, (a) determine 704, from a natural language description 210 of a target machine 208 configuration 124, a machine configuration intention 212 of the natural language description, the machine configuration intention corresponding to a particular machine configuration function 310 which is selected 710 by the language model based on at least the pre-approval data structure, and (b) obtain 712, from the machine configuration intention via at least the language model, a machine configuration task list 302. The machine configuration task list executor 306 is configured to, upon execution by the processor set, configure 714 the target machine at least in part by executing 716 the machine configuration task list.

In some embodiments, the machine configuration task list generator 304 includes an AI-based intent refinement mechanism 214, which upon execution by the processor set utilizes 812 the language model to refine 708 an approximation 308 of the machine configuration intention 212 with respect to at least one of: a version 404 identifier 406, a software 410 identifier 412, a resource 428 identifier 430, or a software 410 setting 414.

In some embodiments, the machine configuration task list generator 304 includes an intent refinement mechanism 214, which upon execution by the processor set utilizes 812 the language model to refine 708 an approximation 308 of the machine configuration intention 212, the intent refinement mechanism including at least one of: a user feedback database 418, a database query interface 426, or a spell checker interface 444.

In some embodiments, the machine configuration task list executor 306 includes an agent 314 residing on a version of the target machine. In this context, “version of the target machine” indicates that the machine on which the agent 314 resides is not necessarily configured by the desired configuration (a.k.a. the target configuration) at every point in time in which the agent resides on that machine.

In some embodiments, the natural language description 210 is associated in the computing system with a user 104 and the machine configuration task list 302 is by default not displayed 818 by the computing system to the user. Thus, the details in the task list 302 are hidden from the user, at least by default. In a variation, the task list 302 is displayed 816 by default.

In some embodiments, the configured target machine 208 includes a virtual machine 632 configured with at least one of: a source code editor 624, a compiler 626, a debugger 628, or a performance profiler 630. Such virtual machines are examples of machines configured as development environments.

Other system embodiments are also described herein, either directly or derivable as system versions of described processes or configured media, duly informed by the extensive discussion herein of computing hardware.

Although specific machine configuration architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of machine configuration functionality, for example, as well as different technical features, aspects, mechanisms, software, expressions, operational sequences, commands, data structures, programming environments, execution environments, environment or system characteristics, or other functionality consistent with teachings provided herein, and may otherwise depart from the particular examples provided.

Processes (a.k.a. Methods)

Processes (which are also be referred to as “methods” in the legal sense of that word) are illustrated in various ways herein, both in text and in drawing figures. FIGS. 7 and 8 each illustrate a family of methods 700 and 800 respectively, which are performed or assisted by some enhanced systems, such as some systems 202 or another machine configuration functionality enhanced system as taught herein. Method family 700 is a proper subset of method family 800.

Some variations on FIG. 7 exclude receiving 702 a natural language description and instead use a previously received natural language description. Some variations on FIG. 7 include receiving 702 multiple natural language descriptions, which are then summarized together as a resultant description 210 which is then processed 704. In some variations, the description 210 is elicited iteratively via model-generated dialog interaction with a user via a user interface. For example, the model may generate a request for clarification of an initial description, or a request for the user to choose between alternatives that are each consistent with the initial description. These are merely examples of variations, as noted elsewhere, any operable combination of steps that are disclosed herein may be part of a given embodiment.

FIGS. 1 to 6 illustrate machine configuration system 202 architectures with implicit or explicit actions, e.g., proactively and automatically accessing product documentation, manual pages, and other sources of human-vetted information about tools, tool extensions, and other aspects of a configuration, training the language model, saving configuration snapshots and restoring a configuration from a snapshot, instantiating a virtual machine, or otherwise processing data 118, in which the data 118 includes, e.g., digital text natural language descriptions 210, configuration function 310 allow-sets 614 and deny-sets 616, digital text configuration task lists 302, digital text configuration intention 212 data, and language model prompts 532 among other examples disclosed herein.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 types or speaks in natural language a description of a desired machine 208, which is captured in the system 202 as a description 210. Natural language means a language that developed naturally, such as English, French, German, Hebrew, Hindi, Japanese, Korean, Spanish, etc., as opposed to designed or constructed languages such as programming languages. Indeed, internal testing indicated generally equivalent outputs 302 for translations of the same command 210 in English, Spanish, Italian, and German, which illustrates some beneficial accessibility functionality of some embodiments. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 8. FIG. 8 is a supplement to the textual examples of embodiments provided herein and the textual descriptions of embodiments provided herein. In the event of any alleged inconsistency, lack of clarity, or excessive breadth due to an aspect or interpretation of FIG. 8, the text of this disclosure shall prevail over that aspect or interpretation of FIG. 8.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 800 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 8 to be non-operable, the sequence S is not within the scope of any claim. Any assertion otherwise is contrary to the present disclosure.

Some embodiments provide or utilize a machine configuration method 800 performed by a computing system 202. In this discussion and generally elsewhere herein, “method” is used in the legal sense and “process” is used in the computer science sense. The machine configuration method includes at least: receiving 702 a natural language description 210 of a target machine 208 configuration 124 (that is, a desired configuration); determining 704, from the natural language description via at least a language model 132, a machine configuration intention 212 of the natural language description, the machine configuration intention being output by the language model in a domain specific language 402, the machine configuration intention corresponding to a particular machine configuration function 310 which is selected 710 by the language model based on at least a predefined set 218 of machine configuration functions; obtaining 712, from the machine configuration intention via at least the language model, a machine configuration task list 302; and configuring 714 a machine 208 at least in part by executing 716 the machine configuration task list.

In some embodiments, the machine configuration intention 212 is determined 704 by one language model and then the task list 302 is generated 304 by another language model. In other embodiments, a single language model produces 704 and 304 both the machine configuration intention and the machine configuration task list.

In some embodiments, determining 704 the machine configuration intention includes automatically: getting 706 an approximation 308 of the machine configuration intention from the language model; and refining 708 the approximation with respect to at least one of: a version identifier 406, a software identifier 412, a resource identifier 430, a software setting 414, or a user feedback 416.

That is, some embodiments in some circumstances perform intent refinement 708. The intent refinement is done by a language model 132 or by other mechanisms 214, e.g., database 420 queries 424, spelling correction 422, or both. Some examples of intent refinement 708 include the following.

Refine a version identifier, e.g., “nodejs 18”->“nodejs 18.14.5”.

Refine a software identifier, e.g., “notepad++”->“notepadplusplus”.

Refine a resource identifier, e.g., “folder”->“directory”.

Refine a software setting, e.g., mouse cursor, font, or theme.

In some embodiments, a user feedback-based refinement 708 is a temporally aware refinement based on an embodiment's use of prior feedback from the user that's originating the command 210. The embodiment uses the prior feedback 416 to steer or correct an AI-generated intent 308. For example, assume that user A previously provided feedback that the customization 124 provided wasn't what user A expected, because the embodiment cloned a repository to C:\repos instead of C:\workspaces. This feedback from a previous instance of the user's utilization of the pipeline is incorporated into the refinement mechanism 214. Suppose the user is attempting to use the customization pipeline 202 and states in a command 210 that the github dot com/microsoft/calculator repo is to be cloned, but the command doesn't specify a target location. The clone repo task has a default location where repos go in the absence of other configuration data, but the embodiment determines from the feedback that this user wants their default location to be somewhere else. In some embodiments, this refinement 708 tracks and reads user-specific default values, which are inferred or derived or extracted from telemetry or user history data 418, or specified directly by a user, depending on the embodiment.

Some embodiments set 802 a language model temperature 506 parameter value 504 to minimize creativity 508, e.g., temperature=0. Some embodiments set 802 a language model nucleus sampling 510 parameter value to use all tokens 514 in a vocabulary 512, e.g., top_p=1.0. Some embodiments set 802 a language model frequency penalty 520 parameter value to avoid a frequency penalty, e.g., frequency_penalty=0.0. Some embodiments set 802 a language model presence penalty 524 parameter value to avoid a presence penalty, e.g., presence_penalty=0.0. Some embodiments perform two, three, or all four of these setting steps.

Some embodiments set 802 values 504 that are close to, but not necessarily exactly at, these specified example values. In practice, each language model parameter 502 has a respective range 516 of permitted values 504, where the size of the range is R. A particular value x is said to lie within N percent of a given value g when the particular value x is within N/100*R of the given value g. For example, in some embodiments the temperature ranges from 0 to 1. In these embodiments, 0, 0.1, and 0.2 are each within 20% of 0, but 0.21 and 0.4 are not within 20% of 0.

In some embodiments, the method 800 includes at least one of: setting 802 a language model temperature parameter value to within 5% of a temperature value that minimizes creativity (e.g., within 5% of temperature=0); setting 802 a language model nucleus sampling parameter value within 5% of a nucleus sampling value that will use all tokens in a vocabulary (e.g., within 5% of top_p=1.0); setting 802 a language model frequency penalty parameter value within 5% of a frequency penalty value that will avoid a frequency penalty (e.g., within 5% of frequency_penalty=0.0); or setting 802 a language model presence penalty parameter value within 5% of a presence penalty value that will avoid a presence penalty (e.g., within 5% of presence_penalty=0.0).

In some embodiments, the determining 704 includes zero-shot learning 602 by the language model to learn 804 the predefined set 218 of machine configuration functions 310.

Some embodiments include a honeytrap 604 in an allow-set of available functions. The honeytrap is also referred to as a “catchall”, “honeypot”, “unknown”, or “other” function. In some embodiments, the determining 704 includes teaching 806 the language model a catchall function 604 in the predefined set 218 of machine configuration functions, and the catchall function corresponds to a null effect machine configuration task 312. As used herein, a “null effect machine configuration task” is a task 312 that does not set or change the machine configuration 124; e.g., a no op, or a task 312 that merely reports a state or value without setting or changing configuration 124.

In some embodiments, the determining 704 includes teaching 806 the language model a predefined set 218 of machine configuration tasks 312 which constrains use of the machine configuration functions 310.

Some embodiments perform an automated validation 808 of the configuration-as-code 302 that is generated 304 by the language model. Configuration-as-code is also referred to herein as infrastructure-as-code. For example, some embodiments perform a semantic validation 808 which helps embodiments either discard a possible fabrication (e.g., model 132 hallucination) or steer the generated task list 302 into a successful version that meets the user's needs. For example, some embodiments check whether a version number makes sense by checking official documentation, e.g., a list of releases. If the version number being checked is found and is the most recent stable version, it is used. If not, then the most recent stable version's number is used in the task list. Some embodiments check 808 whether a task in the list 302 exists, and if it does checks 808 whether the list's recited 824 inputs match the task type, count, etc. This is accomplished in some cases by comparing the task list to trusted (e.g., human-vetted) documentation such as man pages (*nix manual pages). Some embodiments report errors detected by a check 808 and give a user a chance to edit or reject the task list. Some embodiments check 808 whether a task in the list 302 conforms to a formal specification of a task invocation. For example, data such as the content of an internal prototype task.yaml file discussed elsewhere herein is utilized in some embodiments as a formal specification which guides validation of a task 312.

In some embodiments, the method 800 includes automatically and proactively validating 808 the machine configuration task list 302. This validating includes at least one of: checking 808 a syntax 606 of the machine configuration task list; checking 808 whether a path 608 specified in the machine configuration task list exists; checking 808 whether a resource 428 specified in the machine configuration task list is accessible; checking 808 whether a parameter value 622 specified in the machine configuration task list is invalid; or checking 808 whether a required parameter 620 of a routine 310 invocation 612 specified in the machine configuration task list is present.

In some embodiments, the method 800 includes the language model selecting 710 the machine configuration function 310, and the selecting utilizes 810 the predefined set 218 of machine configuration functions as an allow-set 614 and the selected machine configuration function is a member 618 of the predefined set of machine configuration functions. For example, in one scenario the allow-set 614 has members choco, git-clone, and powershell, and the selected machine configuration function is choco.

Note that “powershell” without ® is a command name corresponding to the PowerShell® product (mark of Microsoft Corporation). Other trademarks also appear herein, particularly in source code examples, without an accompanying ® designation. This is not intended as an infringement, derogation, or waiver of any trademark owner's rights, but rather is done merely for convenience and to reflect an industry practice, e.g., command interpreters do not typically require entry of ® in order to execute a command which also happens to be a registered trademark.

In some embodiments, the method 800 includes the language model selecting 710 the machine configuration function 310, and the selecting utilizes 810 the predefined set 218 of machine configuration functions as a deny-set 616 and the selected machine configuration function is not a member 618 of the predefined set of machine configuration functions. For example, in one scenario the deny-set 616 has members rm, mkfs, and wget, and the selected machine configuration function is choco.

### Configured Storage Media

Some embodiments include a configured computer-readable storage medium 112. Some examples of storage medium 112 include disks (magnetic, optical, or otherwise), RAM, EEPROMS or other ROMs, and other configurable memory, including in particular computer-readable storage media (which are not mere propagated signals). In some embodiments, the storage medium which is configured is in particular a removable storage medium 114 such as a CD, DVD, or flash memory. A general-purpose memory, which is be removable or not, and is volatile or not, depending on the embodiment, can be configured in the embodiment using items such as pre-approval data structures 218, machine configuration task lists 302, language models 132, agents 314, machine configuration intentions 212, and intent refinement mechanisms 214, in the form of data 118 and instructions 116, read from a removable storage medium 114 and/or another source such as a network connection, to form a configured storage medium. The configured storage medium 112 is capable of causing a computer system 202 to perform technical process steps for providing or utilizing machine configuration functionality 204 as disclosed herein. The Figures thus help illustrate configured storage media embodiments and process (a.k.a. method) embodiments, as well as system and process embodiments. In particular, any of the method steps illustrated in FIG. 7 or 8, or otherwise taught herein, may be used to help configure a storage medium to form a configured storage medium embodiment.

Some embodiments use or provide a computer-readable storage device 112, 114 configured with data 118 and instructions 116 which upon execution by a processor 110 cause a computing system 202 to perform a machine configuration method 800 which produces a configured target machine 208. This method 800 includes: determining 704, from a natural language description 210 of a target machine configuration 124, a machine configuration intention 212 of the natural language description, the determining including a language model 132 selecting 710 a machine configuration function 310 based on at least a pre-approval data structure 218 which the selecting treats 810 as an allow-set 614 or treats 810 as a deny-set 616, the determined machine configuration intention corresponding to the selected machine configuration function; obtaining 712, from the machine configuration intention via at least the language model, a machine configuration task list 302; and configuring 714 the target machine to produce the configured target machine at least in part by executing 716 the machine configuration task list.

Some embodiments support user review of natural language version of the configuration-as-code 302 that is produced 304 by the language model. In some embodiments, the machine configuration method 800 includes automatically and proactively: acquiring 820 a model-generated natural language description of the machine configuration task list; and displaying 822 the model-generated natural language description in a user interface. In some, the method 800 includes collecting user feedback 416 regarding the displayed 822 description, and submitting the feedback and the description and the task list 302 to a language model with a prompt to adjust the task list based on the feedback.

Language model stability 526 is a consideration in some embodiments and some scenarios. Instability leads to inconsistency in language model responses to prompts 532. Language model stability is sometimes dependent on language model parameters 502. Some different large language models have different stability parameters, and some exhibit different variability between answers to the same question even while using the same stability parameters.

For present purposes, a language model is “large” if it has at least a billion parameters. For example GPT-2 (OpenAI), MegatronLM (NVIDIA), T5 (Google), Turing-NLG (Microsoft), GPT-3 (OpenAI), GPT-3.5 (OpenAI), and GPT-4 (OpenAI) are each a large language model (LLM) 132 for purposes of the present disclosure, regardless of any definitions to the contrary that may be present in the industry.

One internal prototype was developed using a completions functionality of the davinci-text-003 model, which is more stable than GPT-3.5-turbo, which in turn is more stable than GPT-4. GPT-4 can be stabilized by adjusting parameters 502 and constraining the queries sent to a given instance of the model 132. In other words, GPT-4 and the like are stable at the batch level, not at the query level. For a given group of queries 532, using the same parameters (such as temperature, etc.) the model will yield fully consistent results. Queries 532 to a language model 132 are also referred to as prompts 532.

The variability present in general-purpose day-to-day queries 532 to a given general-purpose GPT-4 instance stems from a lack of constraints on which queries are being presented to that instance in the batch of queries that is given to it for processing. In particular, the amount of tokens in the batch matters, and variability in the token count has an effect on the attention heads and on the sparse MoE implementation of these LLMs. MoE stands for “mixture of experts” within a LLM 132. One way to reason about MoE is to view it as a collection of subcomponents of the LLM, each of them providing a body of expertise and also a finite amount of attention to subsections of a given query. If multiple queries are trying to use the LLM expert on writing JSON, for example, it may be the case that some of those queries end up being served by experts who don't know JSON very well due to how the model is trained, particularly due to what training data the model received. In some embodiments, a model 132 is fine-tuned or otherwise trained to be very stable for the particular use cases described herein, e.g., using a body of training data layered on top of a general transformer model 132.

LLMs are deterministic at the batch level, and controlling batches is feasible with control of an instance of the LLM. Unless stated otherwise, when the language model 132 is an LLM instance, that instance 132 is presumed to be subject to query batch constraints in order to promote stability. The level of constraints varies. However, in some embodiments, almost all of the queries sent to the LLM are machine configuration queries. Some suitable values of “almost all” for a query mix 528 are 90%, 95%, and 98%. Machine configuration queries are queries that involve the user's natural language description 210, intent 212, a function 310 (e.g., choco, powershell, etc.), or a task 312 (install notepad++, etc.). In some embodiments, constraining almost all queries to machine configuration queries brings adequate determinism to the output generated by the large language model.

In some embodiments, the machine configuration method 800 includes automatically and proactively performing at least one of: setting 802 a language model temperature 506 parameter value to minimize creativity (e.g., temperature=0); setting 802 a language model nucleus sampling 510 parameter value to use all tokens in a vocabulary (e.g., top_p=1.0); setting 802 a language model frequency penalty 520 parameter value to avoid a frequency penalty (e.g., frequency_penalty=0.0); or setting 802 a language model presence penalty 524 parameter value to avoid a presence penalty (e.g., presence_penalty=0.0).

In some embodiments, the machine configuration method 800 includes stabilizing 814 the language model by limiting presentation of queries 532 to the language model such that at least ninety percent of the queries presented to the language model include at least one of: a machine configuration description 210 in a natural language, a machine configuration intention 212 request 532, a machine configuration intention 212, a machine configuration function 310 request 532, a machine configuration function 310, a machine configuration task 312, or a machine configuration task 312 request 532.

In some embodiments, the natural language description 210 recites 824 at least one of: a software development tool 434; a repository 436 location 438; or a user preference 442 setting.

In some embodiments, the machine configuration method 800 determines 704 multiple machine configuration intentions 212 from at least the natural language description via at least the language model, and the machine configuration method further includes automatically and proactively refining 708 at least one of the machine configuration intentions.

### Additional Observations

Additional support for the discussion of machine configuration functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. With this understanding, which pertains to all parts of the present disclosure, examples and observations are offered herein.

Some embodiments perform configuration of software development environments from natural language prompts. Configuring a computer to do software development activities has often been a lengthy manual process that involves: understanding what tools will be needed to perform the tasks that the end user wants to do, understanding how to acquire said tools, understanding how to configure said tools, performing local cloning of remote source code repositories, and more. This configuration process has sometimes taken two to five days for engineers onboarding to a new company, team, or product.

Some tools 122 output configuration-as-code which encodes a computer configuration in files and scripts. However, configuration-as-code tools often require deeply technical skills to produce a configuration that satisfies the requirements of an end user. For example, with some tools the user is expected to know specific configuration file formats such as JSON or YAML and is also expected to understand how the configuration flow works. As a practical matter, users seek the desired configuration file by trial and error, spending much time in the process. Use of configuration-as-code tools has generally been limited to efforts that yield savings by producing a configuration that will be used many times over, therefore saving an organization time and money. The process however isn't fully scalable, because an end user of a software development environment doesn't typically have access to an expert from an IT department who will spend the necessary time to assist that single user in producing a configuration-as-code file that fully satisfies not just the needs of a project or a team, but that user's own personal ergonomics requirements and preferences.

Some embodiments taught herein include two parts. One part transforms natural language 210 to infrastructure-as-code 302. Another part reads and executes 716 the machine customizations based on the code 302. The computer configuration problem is addressed by allowing an end user to use natural language to describe 210 the desired activity that they wish to perform, or describe 210 the desired tools that they want to install, or describe 210 the desired actions they want the machine to perform to set up their development environment. Embodiments understand the user's intent and provide the user with a fully configured development environment that meets their described needs, in an automated way, using only a small fraction of the time the user would have spent trying to accomplish the same result manually.

In some embodiments, this configuration process involves an iterative approach. The embodiment takes a user's description 210 of what they want their development environment to look like or what kind activity they want to perform in that development environment. Next, the embodiment utilizes a large language model 132 to produce a desired configuration-as-code task list 302 which will accomplish the user's development environment description when executed.

Some embodiments do this configuration by a sequence which includes the following. Derive 704 all the intents 212 in the command 210. For each intent in the user's request, categorize 710 it into a specific function 310. Functions 310 include software installation, cloning repository, downloading asset, executing script, executing command, and more. For each function 310 that's derived, perform refinement 708 actions when there is ambiguity or error, such as filling in version numbers for software packages mentioned in the description 210, or producing sub-intents 212 that go back to the top of the funnel for processing 704-710. For each refined function 310, map 304 it to a concrete task 312 that the embodiment knows how to execute 716, such as installing software via package managers, or configuring Visual Studio® extensions, or cloning repositories, or running PowerShell® scripts (marks of Microsoft Corporation). The translation 712 from function to task is also accomplished by the large language model 132, by prompting it with descriptions of the available tasks and examples of how to use them. Once the mapping from function 310 to task 312 is done, produce 304 the list 302 of task commands in a format 402 understood by an agent 314 that can execute arbitrary code in a virtual machine 632 assigned to the user that initiated the request. This involves, e.g., producing a YAML file that provides configuration-as-code.

A next step in this example is to create a new virtual machine 632 that, once configured, will be assigned to the user that initiated the request 210. Start the configuration agent 314 in the virtual machine before it is assigned to the end user. Send the configuration agent the list 302 of tasks to be performed by the configuration agent. Once the tasks are executed 716, assign the virtual machine to the user so they can utilize it for software development.

Although this example produces a configured software development virtual machine, that is illustrative, not prescriptive. Given the teachings herein, one of skill will adapt this machine configuration technology readily to other software development machines, e.g., laptops or workstations, or to other machines (virtual, or physical, or IoT devices) which are not necessarily tailored for software development, or both.

In some scenarios, an embodiment provides an accessible way to get a fully customized development environment for a user who lacks a computer in the first place. In some scenarios, the user has one computer and utilizes the embodiment to obtain a customized additional computer. The user's computers are not necessarily of the same kind, e.g., in some cases a developer with a laptop utilizes an embodiment to obtain a customized virtual machine 632. In some other scenarios, an embodiment customizes a previously obtained machine.

Some embodiments apply the tasks 312 at any time in a computer's lifetime. Some implement configuration 124 customization commands 210 at any time during the lifetime of a target virtual machine 208, 632. For example, in one scenario user A has been using a virtual machine for six months and now wants to install a new version of software 120 or 122. User A can send a customization command to an embodiment from a portal, e.g., as user interface gestures or as a natural language command 210.

Some embodiments allow entities such as information technology (IT) departments to determine which functions and tasks are available to the end users of the configured target machines. Some embodiments implement an extensibility model that gives organizations control over which customizations can be created, including the ability to perform tasks that are unique to the internal needs of the organization, such as avoiding certain functions 310 or preferring one tool 122 over another generally similar tool 122. IT departments provide access to the capability for users to self-serve new development machines in the cloud, leveraging automatic configuration of the development environment from a natural language prompt, and utilizing either the built-in tasks that can perform a large set of common configuration workloads, or a set 218 of tasks that IT has provided for this purpose in a configuration-as-code format 218 consumable by the artificial intelligence assistant 132 that maps the user's request to the actionable configuration code 302. This beneficially reduces the cost for IT departments to support software development environments, and also beneficially empowers software developers to get productive faster and with less overhead time spent attempting work that is done more efficiently and securely by machines 202.

Some embodiments utilize or provide an interactive flow to query the end user for a more accurate description 210 of their development environment by utilizing large language models. In some, this includes the following. Produce and display 816 the desired state configuration-as-code 302 from the user's initial request, as described elsewhere herein. Before proceeding to run 716 this in a virtual machine, assess the quality of the generated configuration-as-code. Assessment includes: Utilize a large language model to produce a detailed natural language explanation of the work 302 to be done to the computer to configure it. The explanation will not explain the technical tasks to be run, but rather the set of actions to be performed, in a descriptive way. Present the user with the detailed explanation, allowing them to peek into the configuration-as-code that was produced as an optional step if they possess the skills and desire to inspect the configuration that the artificial intelligence assistant produced. Obtain instructions for refinement from the end user based on their assessment and start back at step 704. The refinement is cumulative, taking the original request 210 and applying the refinement commentary to produce a better configuration description 210. Repeat the steps above, until the end user confirms that the configuration description 210 meets their expectations. Proceed to apply the corresponding configuration task list 302 to the virtual machine. Some embodiments communicate back to an end user about operational results, using natural language. This closes a human-computer-human interaction loop.

Some embodiments enable IT control of actions 312 that can be done by the artificial intelligence assistant to configure a software development environment. This beneficially implements governance over what actions can be done and what capabilities are available to users.

Some embodiments enable collaboration between the end user and the artificial intelligence assistant to get to an acceptable configuration. This beneficially provides end users with a quick iteration on their desired software environment configuration, via partnering with their artificial intelligence assistant to get to more accurate results.

Some embodiments enable an end user of a software development environment to get fully personalized machine configurations without the need to spend time learning new systems, file formats, or scripting languages. This beneficially provides end users with the value they seek without imposing on them the cognitive load of alternate configuration code generation systems.

Some embodiments provide an accessibility boost for end-users who receive the benefits of infrastructure-as-code automation without having to deal with code.

Some embodiments take a natural language prompt and produce a ready-to-code machine 208 that leverages the tools and respects the policies set by an IT administration team.

Some embodiments provide a fully configured virtual machine (e.g., a dev box) that satisfies a natural language request 210. The tools and the configuration of the virtual machine are performed by leveraging tasks or other artifacts that the IT administrators have deemed appropriate and secure. For example, a more liberal organization might let a user be an admin of the computer 208, and run any arbitrary command, whereas a highly-regulated bank will not allow any end user outside the IT department to do so, providing instead only certain set of actions during the machine provisioning stage, and thus limiting the range of tasks the user can perform to customize a development environment.

Courtesy of some embodiments, an end user connects to a virtual machine with their tools and settings fully configured to meet their needs. The users don't see (and don't have to create) infrastructure-as-code. Alternately, some embodiments show the user the infrastructure-as-code intermediary as part of confirming with them that this is what they want, at least as an option.

Some embodiments ignore or filter out or politely decline action on irrelevant or otherwise unsuitable descriptions 210. Asking an embodiment for “a grandma joke in the style of a physicist” results in no infrastructural changes made to the virtual machine that the user is requesting. Internally, this command 210 is directed to a honey trap 604 that attracts all requests that don't match a set of known functions, in a categorization that allows the embodiment to ignore the unsuitable request.

Some embodiments leverage a zero-shot learning 602 approach to produce infrastructure-as-code from off-the-shelf language models 132, which is then executed 716 automatically in order to produce the outcome expected by the end user. The end user is not necessarily aware of how the embodiment achieves the outcome. Some end users will likely utilize this approach because they don't want to learn and deal with yet another infrastructure-as-code tool 122 with arbitrarily different specifications or other industry standards. Thus, some embodiments beneficially provide an accessibility enhancement.

Some embodiments ignore requests 210 that are outside of the domain of things a computer personalization program can do.

Some embodiments determine the intent 212 of the end user, and transform it to formally-defined data structures 212, 402 that can be decorated with additional information by a transformation process. Some embodiments take the decorated and structured intents of the end user and map them to the tasks 312 or other capabilities (e.g., virtual machine templates specifying storage and compute capabilities) that the IT administrators have enabled for the end user, including the mapping of specific parameters 620 that the end user specified, to the formal specifications of the tasks or capabilities provided by IT. Some embodiments package and execute 716 the generated infrastructure-as-code instructions in a virtual machine that is being provisioned for a user.

Some embodiments utilize or provide a method 800 of generating runnable development environment configuration instructions. The method 800 includes: defining a set of operations to be available to be run by an agent, which provide configurability to a computer; receiving a first natural language description, which describes a development environment; extracting, via a first large language module, a candidate set of intentions based on at least the different grammatical components of the first natural language description; producing, via a second large language module, a candidate set of configuration-as-code instructions based the candidate set of intentions and the pre-defined set of available operations available to be leveraged by the infrastructure-as-code; and producing a fully configured development environment by executing the synthetized configuration-as-code via a specialized agent in a computer.

Some methods 800 also include creating a second natural language description based on the candidate set of configuration-as-code instructions; validating the second natural language description based on user feedback; and generating, from at least the validated second natural language description, via a third large language module, a refined set of configuration-as-code instructions.

In some scenarios, a system administrator who is not the end user defines the set of operations that can be executed in a computer 208 to modify it; this definition is represented in a system 202 as a pre-approval data structure. For example, as an administrator a user A defines an operation that can run an arbitrary PowerShell® command, or an operation that can install a Visual Studio® integrated development environment 122 (marks of Microsoft Corporation), or an operation that can change the system 208 colors to a dark theme, etc. These are definitions of the permitted operations that the language models consume in order to produce the configuration-as-code, and the agent 314 that configures the computer 208 will also consume and execute 716 the actual code that effectively implements the change that the operation describes.

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP, Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Prototype

As further illustration of teachings presented herein, an internal prototype is now discussed. This prototype discussion is illustrative of embodiment teachings, not prescriptive, and varies in implementation details and architecture from some embodiments. This prototype discussion is not intended to be comprehensive, or to stand on its own. Some customary information one of skill would understand or presume without explication is omitted, such as system configuration data for the prototype itself, as opposed to the illustrative configuration task list produced by the prototype.

In this prototype discussion, tasks 312 are described in a task.yaml format, and the yaml files and accompanying resources (such as PowerShell® scripts) are hand-written files. In some scenarios, such files are provided by an IT admin to create their own approved tasks, and are either added to tasks like those illustrated here, or replace such tasks.

In this prototype discussion, a devbox.yaml file is also handwritten, and it references the tasks available to it. For example, there is a powershell task.yaml, and the devbox.yaml makes use of this task in a setupTasks list.

A taskmaker.py prototype was a proof of concept that demonstrated an ability to ingest natural language text and produce a setupTasks list that represents the user's intent, leveraging metadata provided by the task.yaml files as context to a large language model, in combination with a refined form of the user's natural language input. This refinement is done as the first step of a machine configuration process, where the prototype extracts the intents from the prompt. The intents are then mapped to the task.yaml metadata, which includes examples of how to use each task. The large language model is able to replicate the examples effectively in order to provide the desired result.

The resulting setupTasks list is printed at the bottom of the output files, but in some production systems 202 it would then be interpreted as if a user had written it. The system 202 would do grammar and syntax validation, then do semantic validation (confirming the list 302 is calling real tasks, not fabricated ones), etc. The process continues by sending the validated list of tasks down to the virtual machine that the system 202 is provisioning for the user.

An agent present in the virtual machine 632, 208 is able to read the list of setupTasks, request a download of the required task.yaml and related assets (such as the runcommand.ps1 file) and trigger the execution of the tasks with the parameter values 622 that make the customization of the virtual machine happen.

After all the tasks from the setupTasks list are processed, the resulting virtual machine is fully configured and is released to the end user.

The prototype in this prototype discussion included content in a file named devbox-copilot-prototype.zip, which contained: taskmaker.py under a folder caller prototype1; a folder called tasks with multiple sub-folders, each containing a task.yaml and other assets, including runcommand.ps1 under the powershell folder; and a folder called devbox with a sample devbox.yaml. Also included were files called output-1.txt and output-2.txt with a sample command given to taskmaker, and the resulting output. The command 210 given is in the first line of the text files, and all the content starting on the second line of the text files is the resulting output of running taskmaker.py.

The example source code in this prototype discussion involves an allow-set of AVAILABLE FUNCTIONS. That is, the language model 132 is taught 806 which functions 310 can be part of the generated configuration-as-code 302. However, some embodiments utilize a deny-set approach, in which the language model is taught which functions or tasks cannot be part of the generated configuration-as-code. Some embodiments utilize both an allow-set 614 and a deny-set 616. For example, in one scenario a delete function rm is an allow-set member, but a recursive delete task rm −r is a deny-set member. A deny-set mechanism is utilized by a filter which sanitizes the dataflow pipeline very early on, as opposed to relying only on the constraints of the AVAILABLE TASKS. In other words, in various embodiments constraints are enforced along with, or before, restriction to the AVAILABLE FUNCTIONS.

Some embodiments include an allow-set 614 of available tasks 312 (an allow-set 614 of available functions 310 is also in some of these embodiments). Many AVAILABLE FUNCTIONS can be misused if the tasks are not further limited to authorized AVAILABLE TASKS. For example, in some scenarios powershell is an available function, but that does not mean every possible powershell use should be an available task. In some embodiments, the order of members in a pre-approval data structure 218 such as an allow-set or a deny-set, e.g., the order of entries in a structure 218 such as the prototype AVAILABLE FUNCTIONS or AVAILABLE TASKS structure, is optimized. In some cases, the optimization orders members 618 from specific to generic, so the more specific members will be encountered first during task list generation. For example, a powershell function is more generic than a function such as git-clone which can be accomplished using powershell git command line interpreter (CLI) commands. Placing more specific members higher in a list helps reduce overutilization of their more generic alternatives, which tends to improve security and promote efficient execution 716.

### Prototype Output Example One

The following is from the output-1.txt file, lightly edited for blank line removal, privacy, and compliance with Patent Office regulations regarding hyperlinks.
Enter command: I want to install notepad++ and nodejs 18, clone github dot com/username/carnd to C:\repos, then run C:\repos\carnd\dev-init.ps1
Processing command, please wait . . .
Intents:

```
[
  {
    ″function″: ″installSoftware″,
    ″parameters″: {
      ″software″: [″notepad++″, ″nodejs 18″]
    }
  },
  {
    ″function″: ″cloneRepository″,
    ″parameters″: {
      ″url″: ″github dot com/username/carnd″,
        ″destination″: ″C:\\repos″
    }
  },
  {
    ″function″: ″powershellScriptLocalPath″,
    ″parameters″: {
      ″path″: ″C:\\repos\\carnd\\dev-init.ps1″
    }
  }
]
Refined intent:
{′function′: ′installSoftware′, ′parameters′: {′software′: [′notepad++′,
′nodejs 18.14.5′]}}
Command:
I want to install notepad++ and nodejs 18, clone github dot com/
username/carnd to C:\repos, then run C:\repos\carnd\dev-init.ps1
Generated result:
setupTasks:
- task: choco
  description: install notepad++
  inputs:
    package: notepadplusplus
- task: choco
  description: install nodejs 18.14.5
  inputs:
    package: nodejs
    version: 18.14.5
- task: git-clone
  description: clone this repository into C:\\repos
  inputs:
    url: https colon //github dot com/username/carnd
    directory: C:\\repos
- task: powershell
  description: execute arbitrary powershell command
  inputs:
    command: ./dev-init.ps1
    workingDirectory: C:\\repos\\carnd
```

### Prototype Output Example Two

The following is from the output-2.txt file, lightly edited for blank line removal, privacy, and compliance with Patent Office regulations regarding hyperlinks.
Enter command: clone github dot com/username/carnd, then install python 3.9.6
Processing command, please wait . . .
Intents:

```
[
  {
    ″function″: ″cloneRepository″.
    ″parameters″: {
      ″repository″: ″github dot com/username/carnd″
    }
  },
  {
    ″function″: ″installSoftware″
    ″parameters″: {
      ″software″: ″python″,
      ″version″: ″3.9.6″
    }
  }
]
Refined intent:
{′function′: ′installSoftware′, ′parameters′: {′software′: ′python′, ′version′:
′3.9.6.0′}}
Command:
clone github dot com/username/carnd, then install python 3.9.6
Generated result:
setupTasks:
- task: git-clone
  description: clone this repository into C:\\Workspaces
  inputs:
    url: https colon //github dot com/username/carnd
  directory: C:\\Workspaces
- task: choco
  description: install python 3.9.6.0
  inputs:
    package: python
    version: 3.9.6.0
```

The following is from prototype file taskmaker.py, lightly edited for blank line removal, privacy, and compliance with Patent Office regulations regarding hyperlinks.

```
import os
import openai
import json
import yaml
import re
openai.api_key = os.getenv(“OPENAI_API_KEY”)
def get_intents(command:str) -> str:
  stopToken = ″\″\″\″″
  nl = “\n”
  goal = “goal: ”
```

This portion of taskmaker.py illustrates a pre-approval data structure 218, and in particular an allow-set 614 of pre-approved functions 310. In some commercial embodiments, data structures 218 along the lines of the prototype structure AVAILABLE FUNCTIONS or AVAILABLE TASKS are constructed dynamically.

```
  available Functions = ″″″
  [AVAILABLE FUNCTIONS]
  installSoftware:
    description: User wants to install new applications in their computer
  cloneRepository:
    description: User wants a git repository cloned in their computer
  powershellScriptLocalPath:
    description: User wants to execute a powershell script by providing its local file
path
  powershellScriptUrl:
    description: User wants to execute a powershell script by providing its URL
  unknown:
    description: User wants to do something else
  [END AVAILABLE FUNCTIONS]
″″″″
  intentQuestion = “answer as a JSON array descriptive of the function
requested:”
  promptToken = availableFunctions + nl + goal + command + nl + stopToken +
intentQuestion
```

The following create( ) call in taskmaker.py identifies one of many suitable language models 132, and illustrates setting 802 language model 132 parameter 502 values 504.

```
response = openai.Completion.create(
  model=“text-davinci-003”,
  prompt=promptToken,
  temperature=0,
  max_tokens=1500,
  top_p=1.0,
  frequency_penalty=0.0,
  presence_penalty=0.0,
  stop=[stopToken]
)
```

The prototype file taskmaker.py then continues as shown below. This portion is also lightly edited, e.g., for comment clarity and blank line removal.

```
intents = response.choices[0].text
  # sometimes intents doesn't contain square brackets indicating it's a JSON
array result;
  # if that's the case, append square brackets to the result to make it look like
  # an array
  intents = intents.strip( )
  if intents[0] != “[”:
    intents = “[” + intents + “]”
  return intents
def get_tasks_from_intent(intent:str) -> str:
  stopToken = ″\″\″\″″
  nl = “\n”
  goal = “goal: ”
```

This portion of prototype file taskmaker.py illustrates a pre-approval data structure 218, and in particular an allow-set 614 of pre-approved tasks 312.

```
  available Tasks = ″″″
    [AVAILABLE TASKS]
    git-clone:
      description: clone a git repository
      inputs:
        url: required, the url of the repository to clone
        directory: required, the directory to clone the repository into
        branch: optional, the branch to clone
      examples:
        - task: git-clone
          description: clone this repository into C:\\Workspaces
          inputs:
            url: https colon //github dot com/microsoft/calculator
            directory: C:\\Workspaces
        - task: git-clone
          description: clone this repository's feature/winui2.6 branch into
C:\\Workspaces
          inputs:
            url: https colon //github dot com/microsoft/calculator
            directory: C:\\Workspaces
            branch: feature/winui2.6
    choco:
      description: install application using chocolatey
      inputs:
        package: required, the name of the application to install
        version: optional, the version of the application to install
        flags: optional, arbitrary flags to send to choco
      examples:
        - task: choco
          description: install OracleJDK 17.0.1
          inputs:
            package: oraclejdk
            version: 17.0.1
        - task: choco
          description: install notepad++
          inputs:
            package: notepadplusplus
    powershell:
      description: execute arbitrary powershell command
      inputs:
        command: string containing powershell command
        working Directory: optional, the directory to execute the command in
      examples:
        - task: powershell
          description: print hello world
          inputs:
            command: “Write-Host hello, world!”
        - task: powershell
          description: run script
          inputs:
            command: “./script.ps1”
            workingDirectory: C:\\provisioning\\temp
    [END AVAILABLE TASKS]
    ″″″
    taskQuestion = “answer as a yaml tasks list, item indentation = 0:”
    promptToken = availableTasks + nl + goal + intent + nl + stopToken +
taskQuestion
```

The following create( ) call in taskmaker.py identifies one of many suitable language models 132, and illustrates setting 802 language model 132 parameter 502 values 504. Although it matches the create( ) call above, some embodiments utilize different parameter values 504, different models 132, or both, at different points within the embodiment.

```
    response = openai.Completion.create(
      model=“text-davinci-003”,
      prompt=promptToken,
      temperature=0,
      max_tokens=1500,
      top_p=1.0,
      frequency_penalty=0.0,
      presence_penalty=0.0,
      stop=[stopToken]
    )
    return response.choices[0].text
def refine_install_software_intent(originalIntent):
    stopToken = ″\″\″\″″
    nl = “\n”
    goal = “goal: ”
    taskQuestion = “produce the same JSON but expand version numbers into their
full version numbers, e.g. 1 -> 1.0.0. Omit adding a version number when the
original input doesn't specify a version number:”
The following promptToken in file taskmaker.py is an example of a
prompt 532.
    promptToken = goal + nl + json.dumps(originalIntent) + nl + stopToken +
taskQuestion
    response = openai.Completion.create(
      model=“text-davinci-003”
      prompt=promptToken,
      temperature=0,
      max_tokens=1500,
      top_p=1.0,
      frequency_penalty=0.0,
      presence_penalty=0.0,
      stop=[stop Token]
    )
    return json.loads(response.choices[0].text)
```

In one example run using the prototype, as discussed above in connection with the output files, the command variable below in taskmaker.py receives the command 210 (that is, digital text representing human-readable natural language description 210) noted in the following taskmaker.py comment.

```
# command = “I want to install notepad++ and nodejs 18, clone github dot
com/username/carnd to C:\repos, then run C:\repos\carnd\dev-init.ps1”
command = input(“Enter command: ”)
print(“Processing command, please wait...”)
intents = get_intents(command)
print(“Intents:”)
print(intents)
# convert intent into a JSON object
intentsObject = json.loads(intents)
# start constructing tasks yaml
tasks = “setupTasks:\n”
for i in range(len(intentsObject)):
  intent = intentsObject[i]
  if intent[“function”] == “unknown”:
    # skip it
    continue
  if intent[“function”] == “installSoftware”:
    # does the intent contain a version number? match on regex
    regex = r“(\d+)”
    if re.search(regex, json.dumps(intent)):
      intent = refine_install_software_intent(intent)
      print(“Refined intent:”)
      print(intent)
  newTasks = get_tasks_from_intent(json.dumps(intent))
  newTasks = newTasks.replace(“\ntasks:\n”, “\n”)
  tasks += newTasks
  # append newline when newTasks doesn't end in newline
  if newTasks[−1] != “\n”:
    tasks += “\n”
# format tasks yaml
tasks = tasks.replace(“\\”, “\\\\”)
tasks = yaml.dump(yaml.load(tasks, Loader=yaml.FullLoader), sort_keys=False,
indent=1, width=1000)
print( )
print(“Command:”)
print(command)
print( )
print(“Generated result:”)
print(tasks)
```

A prototype file devbox.yaml contains the following. Some identifiers have been lightly edited for privacy.

```
name: sample
image: microsoftwindowsdesktop_windows-ent-cpc_win11-9999-zzz-zzz
hostInformation: general_i_zzzzzzzz99999999_v2
supportsHibernation: false
setupTasks:
  - task: clone-winget-configurations
  - task: winget
    inputs:
      configurationFile: C:\WinGetConfig\system.yaml
      runAsUser: false
  - task: winget
    inputs:
      configurationFile: C:\WinGetConfig\user.yaml
      runAsUser: true
  - task: winget
    inputs:
      package: 99999zzzzz # sysinternals
      runAsUser: true
  - task: git-clone
    inputs:
      cloneUri: https colon //devdiv dot visualstudio dot
com/DefaultCollection/OnlineServices/_git/azure-devcenter
```

A prototype file choco task.yaml contains the following. In the prototype, the filename “task.yaml” is used for different files in different directories. In this discussion, the directory name or other content is provided for disambiguation.

```
name: choco
command: “./choco.ps1 -Package {{package}}”
inputs:
  package:
    defaultValue: “”
    type: “string”
    required: true
```

A prototype file system.yaml contains the following.

```
# yaml-language-server: $schema= https colon //aka.ms/configuration-dsc-
schema/0.2
# Reference: https colon //github dot com/microsoft/winget-cli-
restsource#building-the-client
properties:
  configurationVersion: 0.2.0
  resources:
    - resource: Microsoft.Windows.Developer/DeveloperMode
      directives:
        description: Enable Developer Mode
        allowPrerelease: true
      settings:
        Ensure: Present
    - resource: Microsoft.WinGet.DSC/WinGetPackage
            directives:
        description: Install Notepad++
        allowPrerelease: true
      settings:
        id: Notepad++.Notepad++
        source: winget
    - resource: Microsoft.WinGet.DSC/WinGetPackage
      directives:
        description: Install .NET SDK
        allowPrerelease: true
      settings:
        id: Microsoft.DotNet.SDK.6
        source: winget
    - resource: Microsoft.WinGet.DSC/WinGetPackage
      directives:
        description: Install Visual Studio 2022
        allowPrerelease: true
      settings:
        id: Microsoft.VisualStudio.2022.Enterprise.Preview
        source: winget
    - resource: Microsoft.WinGet.DSC/WinGetPackage
      directives:
        description: Install Azure CLI
        allowPrerelease: true
      settings:
        id: Microsoft.AzureCLI
        source: winget
```

A prototype file task.yaml contains the following. name: clone-winget-configurations command: ‘./main.ps1’

A prototype file user.yaml contains the following.

```
# yaml-language-server: $schema= https colon //aka.ms/configuration-dsc-
schema/0.2
# Reference: https colon //github dot com/microsoft/winget-cli-
restsource#building-the-client
properties:
  configurationVersion: 0.2.0
  resources:
    - resource: Microsoft.WinGet.DSC/WinGetPackage
      directives:
        description: Install VS Code
        allowPrerelease: true
      settings:
        id: Microsoft.VisualStudioCode
        source: winget
    - resource: Microsoft.WinGet.DSC/WinGetPackage
      directives:
        description: Install Git
        allowPrerelease: true
      settings:
        id: Git.Git
        source: winget
    - resource: Microsoft.WinGet.DSC/WinGetPackage
      directives:
        description: Install Postman
        allowPrerelease: true
      settings:
        id: Postman.Postman
        source: winget
```

A prototype file git-clone task.yaml contains the following.

```
name: git-clone
command: “./main.ps1 -CloneUri {{cloneUri}}”
inputs:
  cloneUri:
    type: string
    defaultValue: “”
    required: true
```

A prototype file install-vs-extension task.yaml contains the following.

```
# This is a Visual Studio extension installation task for Dev Box.
name: install-vs-extension
description: Installs a Visual Studio extension
author: Microsoft Corporation
command: “.\\Install-VSIXExtension.ps1 -MarketplaceItemName
{marketplaceItemName}}”
inputs:
  marketplaceItemName:
    type: string
    required: true
    description: |
      The name of the Visual Studio extension to install.
      For example, “GitHub.copilotvs”.
      Visit https colon //marketplace. visualstudio dot com to learn
      more about Visual Studio extensions.
```

A prototype file powershell task.yaml contains the following. # This is a simple powershell command execution task for Dev Box.

```
name: powershell
description: Execute a powershell command
author: Microsoft Corporation
command: “.\\runcommand.ps1 -command {{command}} -workingDirectory
{{workingDirectory}}”
inputs:
  command:
    type: string
    defaultValue: “”
    required: true
    description: The command to execute
  working Directory:
    type: string
    defaultValue: “”
    required: false
    description: The working directory to execute the command in
```

A prototype file winget task.yaml contains the following.

```
name: winget
command: “./main.ps1 -ConfigurationFile {{configurationFile}} -DownloadUrl
{downloadUrl}} -Package {{package}} -RunAsUser {{runAsUser}}”
inputs:
  configurationFile:
    defaultValue: “”
    type: “string”
    required: false
  downloadUrl:
    defaultValue:
    type: “string”
    required: false
  package:
    defaultValue: “”
    type: “string”
    required: false
  runAsUser:
    defaultValue: false
    type: “boolean”
    required: false
```

### Technical Character

The technical character of embodiments described herein will be apparent to one of ordinary skill in the art, and will also be apparent in several ways to a wide range of attentive readers. Some embodiments address technical activities such as transforming natural language 210 into a domain specific language 402 by executing a language model 132, defining and utilizing a pre-approval data structure 218, communicating with an agent 314 on a target machine 208, and configuring 714 a virtual machine 632, which are each an activity deeply rooted in computing technology. Some of the technical mechanisms discussed include, e.g., language models 132, intent refinement mechanisms 214, scripts such as taskmaker.py which serve as machine configuration task list generators 304 in combination with a language model 132, and interfaces 134, 316, 420, 410, 426. Some of the technical effects discussed include, e.g., production of a configured virtual machine 208 from a natural language description 210, reduced burden on software developers to learn configuration-as-code details, reduced burden on admins to answer the same configuration questions from different users, faster availability of customized machines 208, and efficient constraints on functions 310 and tasks 312 used to customize machines 208. Thus, purely mental processes and activities limited to pen-and-paper are clearly excluded. Other advantages based on the technical characteristics of the teachings will also be apparent to one of skill from the description provided.

One of skill understands that machine configuration generally is a technical activity which cannot be performed mentally, because it requires changing variables, installing software, and otherwise altering the state of computing system memory 112. As disclosed herein, pre-approval-based machine configuration also involves execution of language models 132, which cannot be performed mentally or manually. Moreover, mental or pen-and-paper activity cannot configure a computing system with a customized configuration 124 as described herein. One of skill also understands that attempting to perform machine configuration even in part manually would create unacceptable delays in program execution, pose security risks, and introduce a severe risk of human errors that can cause programs to crash or violate IT policies. People manifestly lack the speed, accuracy, memory capacity, and specific processing capabilities required to perform machine configuration 800.

In particular, pre-approval-based machine configuration is a part of computing technology. Hence, the machine configuration improvements such as functionality 204 described herein are improvements to computing technology.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as Microsoft Dev Box or system configuration tools or tools which deploy virtual machines based on user-provided specifications.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas, they are not.

Rather, the present disclosure is focused on providing appropriately specific embodiments whose technical effects fully or partially solve particular technical problems, such as how to provide customized development environments faster without burdening developers and admins, how to refine natural language requests regarding a desired machine configuration, how to deal with unexpected, profane, silly or otherwise unsuitable requests regarding a desired machine configuration, how to catch and mitigate language model fabrications or other errors regarding a desired machine configuration, and how to efficiently support self-serve machine configuration without creating security vulnerabilities. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Note Regarding Hyperlinks

Portions of this disclosure refer to URLs, hyperlinks, IP addresses, and/or other items which might be considered browser-executable codes. These items are included in the disclosure for their own sake to help describe some embodiments, rather than being included to reference the contents of the web sites or files that they identify. Applicants do not intend to have any URLs, hyperlinks, IP addresses, or other such codes be active links. None of these items are intended to serve as an incorporation by reference of material that is located outside this disclosure document. Thus, there should be no objection to the inclusion of these items herein. To the extent these items are not already disabled, it is presumed the Patent Office will disable them (render them inactive as links) when preparing this document's text to be loaded onto its official web database. See, e.g., United States Patent and Trademark Manual of Patent Examining Procedure § 608.01(VII).

Acronyms, abbreviations, names, and symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
JSON: JavaScript® Object Notation (mark of Oracle America, Inc.).
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network
YAML: yet another markup language, or YAML ain't markup language

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud 136 may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Machine configuration operations such as executing a language model 132, executing a task list 302, and many other operations discussed herein (whether recited in the Figures or not), are understood to be inherently digital. A human mind cannot interface directly with a CPU or other processor, or with RAM or other digital storage, to read and write the necessary data to perform the machine configuration steps 800 taught herein even in a hypothetical or actual prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities, it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as acquiring, checking, configuring, determining, displaying, executing, generating, getting, identifying, invoking, learning, obtaining, producing, prompting, querying, receiving, reciting, refining, setting, stabilizing, teaching, utilizing, validating (and acquires, acquired, checks, checked, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms, separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe aspects of embodiments by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
101 machine in a system 102, e.g., any device having at least a processor 110 and a memory 112 and also having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or set of processors; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, security controls; computational
124 machine configuration; computing system state such as installed software and its settings, environment variable values, and installed resources
126 display screens, also referred to as “displays”
128 computing hardware not otherwise associated with a reference number 106, 108, 110, 112, 114
130 user interface in a computing system
132 language model, e.g., large language model (LLM), multimodal language model, foundation model; also referred to as instance 132, artificial intelligence assistant, model
134 interface to a language model, e.g., API
136 cloud, also referred to as cloud environment or cloud computing environment
202 enhanced computing system, i.e., system 102 enhanced with functionality 204 as taught herein
204 pre-approval-based machine configuration functionality (also referred to as “machine configuration functionality”, “functionality 204”), e.g., software or specialized hardware which performs or is configured to perform steps 704, 710, and 712, or steps 708, 710, and 712, or step 806 to enable one or more of step 704 or step 710 or step 712, or any software or hardware which performs or is configured to perform a novel method 800 or a computational machine configuration functionality activity first disclosed herein
206 computationally produce a configured machine utilizing a method 800
208 configured device or other machine 101 per a command 210, or machine to be configured or being configure per a command 210; also referred to as target machine 208, desired machine 208, machine 208, ready-to-code machine 208, customized machine 208, system 208, computer 208 (for computers), virtual machine 208 (for virtual machines)
210 natural language description of a target machine 208; also referred to as command 210, natural language 210, description 210, request 210; 210 also refers to the computational activity of representing a description 210 in a computing system; an example of a natural language description 210 is “I want to install nodejs 18”
212 user intent, as representing in a computing system; also referred to as intention 212, data structure 212; a sub-intent 212 is an intent 212 in its own right; an example of a machine configuration intention is a JSON intent structure, possibly with an accompanying refined intent
214 intent refinement mechanism is a computing system; also referred to as mechanism 214
216 pre-approval, includes approving or disapproving an action or state or capability as part of an particular machine configuration 124 or a group of machine configurations 124 prior to a machine configuration 714 activity that produces or attempts to produce such a machine configuration 124
218 pre-approval data structure, e.g., allow-set or deny-set for functions or tasks or both; representation in a computing system 202 of a pre-approval 216; 218 also refers to a set generally, as represented in a computing system; lists are ordered sets
302 machine configuration task list in a computing system; also referred to as configuration-as-code, infrastructure-as-code, task list, list 302, code 302, work 302
304 machine configuration task list generator; computational; 304 also refers to the computational activity of creating or modifying a task list 302
306 machine configuration task list executor, e.g., agent 314; computational
308 approximation of an intent 212, as represented in a computing system; an approximation 308 is an intent 212 in its own right but is subject to refinement 708 to reduce ambiguity or prevent execution 716 error
310 machine configuration function, as represented in a computing system; also referred to as function 310 or routine 310; some examples of a machine configuration function are choco, install, git-clone, and commands read and executed via a shell or other command interpreter; in the example prototype source code, a predefined set of machine configuration functions is designated as AVAILABLE FUNCTIONS
312 machine configuration task, as represented in a computing system; also referred to as action 312; in the example prototype source code, a machine configuration task list is a response to taskQuestion
314 agent capable of executing 716 a configuration task 312 in a computing system
316 interface generally in a computing system; computational, digital
402 domain specific language, e.g., JSON or YAML, in a computing system; also referred to as format 402, formally-defined data structure 402
404 version of a program, e.g., version of a kernel 120 or a tool 122, as represented in a computing system
406 version identifier in a computing system; digital
408 identifier in a computing system; digital
410 software in a computing system, e.g., a kernel 120 or a tool 122
412 software identifier in a computing system; digital
414 software setting in a computing system; digital
416 user feedback in a computing system; digital
418 database in a computing system; digital
420 database interface in a computing system, e.g., API
422 spellchecker in a computing system; computational
424 query in a computing system; digital
426 query interface in a computing system, e.g., API
428 resource in a computing system, e.g., file, hardware 110, 112, 126, 128, API, address, etc.
430 resource identifier in a computing system; digital
432 development of software or hardware, as represented by computational activity and data 118 in a computing system
434 development tool, e.g., compiler, debugger, editor, profiler, testing suite, etc.
436 software repository; computational, digital
438 software repository location, as represented in a computing system
440 model-generated natural language description, as opposed to description originating at a human source; descriptions 210 are presumed to originate at a human source, unless they are described or designated as model-generated 440
442 user preference, as represented in a computing system; digital
444 spell checker interface; computational
500 computationally tailor a language model, e.g., by constraining queries 532, setting parameters 502, or both
502 language model parameter; digital
504 language model parameter value; digital
506 language model temperature parameter; digital
508 language model creativity, as represented by language model output
510 language model nucleus sampling parameter; digital
512 language model vocabulary; digital
514 language model vocabulary token; digital
516 range of a language model parameter; digital
518 language model token frequency; digital
520 language model frequency penalty parameter; digital
522 language model token presence; digital
524 language model presence penalty parameter; digital
526 language model stability, as represented by language model input-output pairs
528 language model query mix; digital
530 threshold; digital
532 language model prompt; also referred to as query or request; digital
602 zero-shot learning; computational
604 catchall function, as represented in a computing system
606 syntax, as represented in a computing system
608 path to a resource, as represented in a computing system
610 routine, e.g., procedure or function, as represented in a computing system
612 invocation of a routine, as represented in a computing system
614 allow-set, as represented in a computing system
616 deny-set, as represented in a computing system
618 member of a set, as represented in a computing system; lists are ordered sets
620 function 310 parameter, as represented in a computing system
622 function 310 parameter value, as represented in a computing system
624 editor tool 122
626 compiler tool 122
628 debugger tool 122
630 profiler tool 122
632 virtual machine in a computing system
700 flowchart; 700 also refers to machine configuration methods that are illustrated by or consistent with the FIG. 7 flowchart or any variation of the FIG. 7 flowchart described herein
702 computationally receive a description 210, e.g., as text or sound or user gesture encoding, via a user interface API or other interface
704 computationally determine a machine configuration intent
706 computationally get an approximation 308, e.g., via an API
708 computationally refine an intent 212
710 computationally select a function 310 based at least in part on an intent 212; also referred to as categorize 710, map 710
712 computationally obtain or create or update a task list 302; also referred to as translate 712, produce 712, generate 712
714 computationally configure a machine 208, e.g., by setting or changing state in the machine's memory 112 through software install, software update, or other activity taught herein
716 computationally execute a task 312 or a task list 302
800 flowchart; 800 also refers to machine configuration methods that are illustrated by or consistent with the FIG. 8 flowchart, which incorporates the FIG. 7 flowchart and other steps taught herein, or methods that are illustrated by or consistent with any variation of the FIG. 8 flowchart described herein
802 computationally set a language model parameter value, e.g., via an interface 134
804 computationally learn; performed by a language model
806 computationally teach a language model, e.g., via prompts
808 computationally check or validate a parameter value, a function existence, a syntax, or another aspect of a task list
810 computationally utilize a set 218, e.g., to control content of a task list 302, treat a set as an allow-set or as a deny-set
812 computationally utilize a language model, e.g., to select 710 a function, to generate a description 440, to produce 712 a task list 302
814 computationally stabilize a language model, e.g., by constraining prompts 532 based on their content, setting parameters 502, or both
816 computationally display a task list 302, e.g. via a user interface
818 computationally avoid displaying a task list 302 in the absence of a user request for such display
820 computationally acquire a task list summary 440
822 computationally display a task list summary 440, e.g. via a user interface
824 computationally recite particular content or subject matter pertaining to particular content, by including it (or by not excluding it when already present) in a description 210
826 any step or item discussed in the present disclosure that has not been assigned some other reference numeral; 826 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

Some embodiments determine 704 machine configuration intentions 212 from a natural language description 210 of a target machine 208 configuration 124. Intentions 212 are refined 708 to remove ambiguity, and mapped 710 to pre-approved configuration functions 310 and tasks 312. A machine configuration task list 302 which invokes the pre-approved 216 configuration functions and tasks is generated 712 by a stabilized 814 language model 132, and is executed 716 to configure 714 a target machine 208, such as a target virtual machine 632. The requested target machine 208 is produced 206 without requiring a user or admin to spend substantial effort and time customizing the machine and confirming its security and policy compliance.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A machine configuration method performed by a computing system, the machine configuration method comprising:
receiving a natural language description of a target machine configuration;
determining, from the natural language description via at least a language model, a machine configuration intention of the natural language description, the machine configuration intention being output by the language model in a domain specific language, the machine configuration intention corresponding to a particular machine configuration function which is selected by the language model based on at least a predefined set of machine configuration functions;
obtaining, from the machine configuration intention via at least the language model, a machine configuration task list; and
configuring a machine at least in part by executing the machine configuration task list.

2. The method of claim 1, wherein determining the machine configuration intention comprises automatically:
getting an approximation of the machine configuration intention from the language model; and
refining the approximation with respect to at least one of: a version identifier, a software identifier, a resource identifier, a software setting, or a user feedback.

3. The method of claim 1, further comprising at least one of:
setting a language model temperature parameter value to within 5% of a temperature value that minimizes creativity;
setting a language model nucleus sampling parameter value within 5% of a nucleus sampling value that will use all tokens in a vocabulary;
setting a language model frequency penalty parameter value within 5% of a frequency penalty value that will avoid a frequency penalty; or
setting a language model presence penalty parameter value within 5% of a presence penalty value that will avoid a presence penalty.

4. The method of claim 1, wherein the determining comprises zero-shot learning by the language model to learn the predefined set of machine configuration functions.

5. The method of claim 1, wherein the determining comprises teaching the language model a catchall function in the predefined set of machine configuration functions, and wherein the catchall function corresponds to a null effect machine configuration task.

6. The method of claim 1, wherein the determining comprises teaching the language model a predefined set of machine configuration tasks which constrains use of the machine configuration functions.

7. The method of claim 1, further comprising automatically and proactively validating the machine configuration task list, wherein the validating comprises at least one of:
checking a syntax of the machine configuration task list;
checking whether a path specified in the machine configuration task list exists;
checking whether a resource specified in the machine configuration task list is accessible;
checking whether a parameter value specified in the machine configuration task list is invalid; or
checking whether a required parameter of a routine invocation specified in the machine configuration task list is present.

8. The method of claim 1, comprising the language model selecting the machine configuration function, wherein the selecting utilizes the predefined set of machine configuration functions as an allow-set and the selected machine configuration function is a member of the predefined set of machine configuration functions.

9. The method of claim 1, comprising the language model selecting the machine configuration function, wherein the selecting utilizes the predefined set of machine configuration functions as a deny-set and the selected machine configuration function is not a member of the predefined set of machine configuration functions.

10. A computing system which is configured to produce a configured target machine, the computing system comprising:
a digital memory;
a processor set comprising at least one processor, the processor set in operable communication with the digital memory;
a machine configuration task list generator comprising a language model;
a pre-approval data structure residing in the memory and representing a set of machine configuration functions;
a machine configuration task list executor;
wherein the machine configuration task list generator is configured to, upon execution by the processor set and via at least the language model, (a) determine, from a natural language description of a target machine configuration, a machine configuration intention of the natural language description, the machine configuration intention corresponding to a particular machine configuration function which is selected by the language model based on at least the pre-approval data structure, and (b) obtain, from the machine configuration intention via at least the language model, a machine configuration task list; and
wherein the machine configuration task list executor is configured to, upon execution by the processor set, configure the target machine at least in part by executing the machine configuration task list.

11. The computing system of claim 10, wherein the machine configuration task list generator comprises an AI-based intent refinement mechanism, which upon execution by the processor set utilizes the language model to refine an approximation of the machine configuration intention with respect to at least one of: a version identifier, a software identifier, a resource identifier, or a software setting.

12. The computing system of claim 10, wherein the machine configuration task list generator comprises an intent refinement mechanism, which upon execution by the processor set utilizes the language model to refine an approximation of the machine configuration intention, the intent refinement mechanism comprising at least one of: a user feedback database, a database query interface, or a spell checker interface.

13. The computing system of claim 10, wherein the machine configuration task list executor comprises an agent residing on a version of the target machine.

14. The computing system of claim 10, wherein the natural language description is associated in the computing system with a user, and wherein the machine configuration task list is by default not displayed by the computing system to the user.

15. The computing system of claim 10, wherein the configured target machine comprises a virtual machine configured with at least one of: a source code editor, a compiler, a debugger, or a performance profiler.

16. A computer-readable storage device configured with data and instructions which upon execution by a processor cause a computing system to perform a machine configuration method which produces a configured target machine, the machine configuration method comprising:
determining, from a natural language description of a target machine configuration, a machine configuration intention of the natural language description, the determining comprising a language model selecting a machine configuration function based on at least a pre-approval data structure which the selecting treats as an allow-set or treats as a deny-set, the determined machine configuration intention corresponding to the selected machine configuration function;
obtaining, from the machine configuration intention via at least the language model, a machine configuration task list; and
configuring the target machine to produce the configured target machine at least in part by executing the machine configuration task list.

17. The computer-readable storage device of claim 16, wherein the machine configuration method further comprises automatically and proactively:
acquiring a model-generated natural language description of the machine configuration task list; and
displaying the model-generated natural language description in a user interface.

18. The computer-readable storage device of claim 16, wherein the machine configuration method further comprises stabilizing the language model by limiting presentation of queries to the language model such that at least ninety percent of the queries presented to the language model include at least one of: a machine configuration description in a natural language, a machine configuration intention request, a machine configuration intention, a machine configuration function request, a machine configuration function, a machine configuration task, or a machine configuration task request.

19. The computer-readable storage device of claim 16, wherein the machine configuration method further comprises automatically and proactively performing at least one of:
setting a language model temperature parameter value to minimize creativity;
setting a language model nucleus sampling parameter value to use all tokens in a vocabulary;
setting a language model frequency penalty parameter value to avoid a frequency penalty; or
setting a language model presence penalty parameter value to avoid a presence penalty.

20. The computer-readable storage device of claim 16, wherein the machine configuration method determines multiple machine configuration intentions from at least the natural language description via at least the language model, and wherein the machine configuration method further comprises automatically and proactively refining at least one of the machine configuration intentions.
